(19) United States
(12) Patent Application Publication
(10) Pub. No.: US 2010/0226362 A1
(43) Pub. Date: Sep. 9, 2010

(54) Intelligent Call Mapping and Routing for Low Cost Global Calling on Mobile Devices Including SmartPhones

(75) Inventors: Jaewoo Kim, San Jose, CA (US); Kyoungsig Kim, Pleasanton, CA (US)

Correspondence Address: PATENT LAW GROUP LLP, 2635 NORTH FIRST STREET, SUITE 223, SAN JOSE, CA, 95134, US

(73) Assignee: INNODIAL COMMUNICATIONS, INC., San Jose, CA (US)

(21) Appl. No.: 12/718,845

(22) Filed: Mar. 5, 2010

Related U.S. Application Data
(60) Provisional application No. 61/158,336, filed on Mar. 6, 2009.

(51) Int. Cl. H04L 12/66; H04M 15/06

(52) U.S. Cl. 370/352; 379/142.05

(57) ABSTRACT

A method for providing international telephone call service to a calling party using a PSTN enabled communication device includes dialing the destination telephone number and establishing a connection between a software application installed on the communication device and an application server, authenticating the calling party using the user ID and the caller ID. When the calling party is authenticated, the method includes assigning a local DID number having the same or a nearby area code as the caller ID, notifying the communication device of the assigned local DID number, storing the destination telephone number and the assigned local DID number in a database, initiating a telephone connection over the PSTN to control signaling servers by dialing the assigned local DID number, retrieving the destination telephone number associated with the local DID number from the database, and establishing a voice-based connection between the caller and the callee.

### CROSS-REFERENCE TO RELATED APPLICATIONS

This application claims the benefit of U.S. Provisional Patent Application Ser. No. 61/158,336, filed on Mar. 6, 2009, which application is incorporated herein by reference in its entirety.

### FIELD OF THE INVENTION

The invention relates to telecommunication systems and methods and, in particular, to a system and a method for low cost global calling from a landline telephone or a mobile device.

### DESCRIPTION OF THE RELATED ART

International calling from a mobile device using a calling card is known. The conventional calling card methods require manual entry of a large number of digits, such as the access number, the caller account number and a personal identification number (PIN). Use of calling cards from a mobile phone is therefore inconvenient to the users.

One method for global dialing from a mobile device using a virtual calling card is described in US 2008/0039074. The virtual calling card feature requires the user to install a software application onto the mobile communication device. The software application serves as a secondary phone directory, separate from the mobile communication device's main phone directory. The user places a call by selecting a contact from the secondary phone directory. After user authentication, the software sends the destination telephone number to a gateway using DTMF tones over a PSTN connection. The gateway converts the DTMF tones to destination number digits and pass the digits to a softswitch to place the actual call.

Other methods for global dialing rely on a web browser or rely on text messaging, such as short message service (SMS), to relay local calling numbers to the calling parties.

### SUMMARY OF THE INVENTION

According to one embodiment of the present invention, a method for providing international telephone call service to a calling party using a public switched telephone network (PSTN) enabled communication device includes launching a software application installed on the communication device of the calling party; dialing a destination telephone number; establishing a connection over a mobile data network between the software application and an application server; providing an user identification (user ID) and a caller identification (caller ID) of the calling party and the destination telephone number to the application server; authenticating the calling party using the user ID and the caller ID; when the calling party is authenticated, assigning a local direct inward dial (DID) number having the same area code as the caller ID or having a neighboring area code as the caller ID; notifying the communication device of the calling party of the assigned local DID number through the mobile data network; storing the mapping of the assigned local DID number to the destination telephone number associated with the calling party in a database; initiating a telephone connection over the PSTN to the destination telephone number by dialing the assigned local DID number from the PSTN enabled communication device; authenticating the calling party using the caller ID of the calling party; when the calling party is authenticated, retrieving the destination telephone number associated with the assigned local DID number from the database; and establishing a voice-based connection between the communication device of the calling party and a communication device of a receiving party associated with the destination telephone number.

According to another aspect of the present invention, a system for providing international telephone call service to a calling party using a public switched telephone network (PSTN) enabled communication device includes a software application installed on the communication device of the calling party; an application server in communication with the software application through a mobile data network where the application server is configured to authenticate the calling party's identity and to assign a local direct inward dial (DID) number mapped to a destination telephone number associated with the calling party; a database in communication with the application server configured to store a mapping table of local DID numbers to destination telephone numbers for one or more calling parties; control signaling servers in communication with the PSTN and the database to establish an Internet telephony call session, to authenticate the calling party's identity, to retrieve the destination telephone number mapped to a local DID number associated with the calling party, and to route the call session to an intended destination telephone number. In operation, the calling party launches the software application and dials the destination telephone number, the application server assigns a local DID number mapped to the destination telephone number to the calling party; the software application, upon receiving the assigned local DID number, initiates a telephone connection over the PSTN. The control signaling servers, after performing authentication of the calling party and retrieving the destination telephone number mapped to the assigned local DID number, establishes a voice-based connection between the communication device of the calling party and a communication device of a receiving party associated with the destination telephone number.

According to yet another aspect of the present invention, a method for providing international telephone call service to a calling party using a public switched telephone network (PSTN) enabled communication device includes initiating a telephone connection over the PSTN to the destination telephone number by dialing the destination telephone number; establishing a connection over a mobile data network between a software application installed on the communication device of the calling party and an application server; providing an user identification (user ID), a caller identification (caller ID) and the destination telephone number to the application server; authenticating the calling party using the user ID and the caller ID of the calling party; when the calling party is authenticated, assigning a local direct inward dial (DID) number having the same area code as the caller ID or having a neighboring area code as the caller ID; notifying the communication device of the calling party of the assigned local DID number through the mobile data network; storing the destination telephone number received from the communication device of the calling party and the assigned local DID number in a database; initiating a telephone connection over the PSTN to SIP servers or softswitch by dialing the assigned local DID number; authenticating the calling party using the caller ID of the calling party; when the calling party is authenticated, retrieving the destination telephone number associated with the local DID number and the caller ID of the calling party from the database; and establishing a voice-based connection between the communication device of the calling party and a communication device of a receiving party associated with the destination telephone number.

The present invention is better understood upon consideration of the detailed description below and the accompanying drawings.

### BRIEF DESCRIPTION OF THE DRAWINGS

FIG. 1 is a system diagram of a call mapping and routing system according to one embodiment of the present invention.

FIG. 2 is a block diagram of the Application Server in the call mapping and routing system of FIG. 1 according to one embodiment of the present invention.

FIG. 3 is a block diagram of the Control Signaling Servers in the call mapping and routing system of FIG. 1 according to one embodiment of the present invention.

FIG. 4 is a flowchart illustrating the call mapping and routing method using an installed software application on the mobile device according to one embodiment of the present invention.

FIG. 5 is a flowchart illustrating the call mapping and routing method without using a mobile data network according to one embodiment of the present invention.

### DETAILED DESCRIPTION OF THE PREFERRED EMBODIMENTS

According to principles of the present invention, a call mapping and routing system and method enables mobile devices or landline telephone devices to place low cost international calls using pre-assigned local direct inward dial (DID) numbers. In one embodiment, the call mapping and routing system and method permit PSTN-network enabled mobile device users to place low cost international calls using the mobile carrier PSTN network. The call mapping and routing system and method of the present invention integrate voice over Internet protocol (VoIP) and public switched telephone network (PSTN) intelligently to enable low cost international calling, especially for mobile devices.

The call mapping and routing system and method of the present invention realize many advantages. In particular, the system and method provide a low-cost international calling alternative to high-cost mobile wireless services by providing a system and method on the mobile devices that automates user authentication, billing, routing, and connection to international parties. In this manner, the call mapping and routing system and method of the present invention realize a simple, easy-to-use, and cost-effective international calling system for mobile device users.

The call mapping and routing system and method of the present invention can be implemented with or without a mobile data network. A mobile device user can make low cost international calls even when there is no Wi-Fi or mobile data network availability. A data network is only required for initial user registration and optional contact list set up. Once the user registration is completed, calls can be placed from mobile devices or landline telephone using the call mapping and routing method of the present invention without a mobile data network. More specifically, once user registration is completed, the user can places international calls using local DID numbers that have been previously assigned and stored for that user. The pre-assigned local DID numbers are mapped to desired destination numbers and associated with the user identification (user ID) of the user, as will be described in more details below.

In one embodiment, the call mapping and routing system of the present invention is integrated with the mobile device's pre-existing contact directory or phonebook for the ease of use. Calls can be placed by selecting a contact directly from the mobile device's pre-existing contact directory. In another embodiment, the call mapping and routing system of the present invention provides a contact directory or phonebook that operates independent of the mobile device's pre-existing contact directory or phonebook.

In the present description, “mobile devices” refers to wireless public switched telephone network (PSTN) enabled mobile communication devices. Mobile devices include cell phones, call-enabled personal data assistants, smartphones, such as the iPhone manufactured by Apple Inc., Cupertino, Calif., Palm Devices by Palm Inc., Sunnyvale, Calif., Android G1-like Devices by Google Inc, and Blackberry Devices by Research In Motion, Ontario, Canada. In the present description, “landline telephone” refers to PSTN wired communication devices, such as Plain Old Telephone Service (POTS) telephones.

A salient feature of the call mapping and routing system and method of the present invention is that a mobile device user can place a local call to connect to international parties. In other words, mobile device users only pay local call charge to their mobile carriers while making international calls from their mobile devices. More specifically, when a mobile device user dials an international number utilizing the call mapping and routing system and method of the present invention, the call mapping and routing system and method intelligently map the international number to a local direct inward dial (DID) number so that the mobile device can establish the international call merely by dialing the mapped local DID number and paying only local call charges.

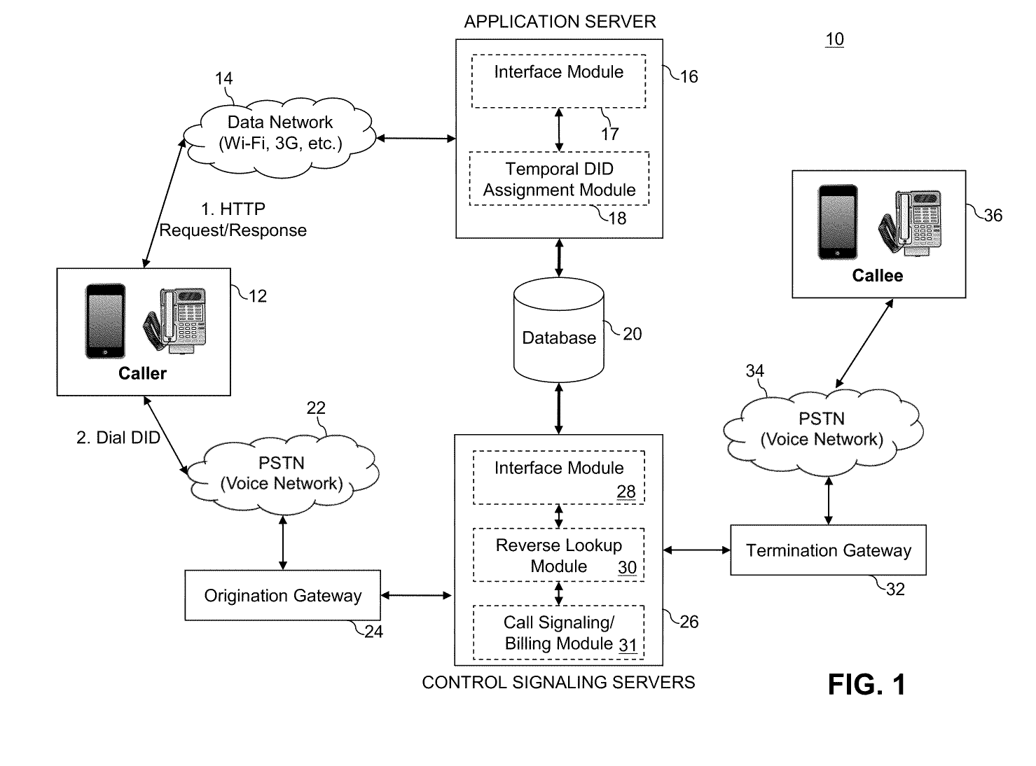

FIG. 1 is a system diagram of a call mapping and routing system according to one embodiment of the present invention. Referring to FIG. 1, a call mapping and routing system 10 is accessible by a caller 12 using a mobile device or a landline telephone. For initial user set up and registration, communication over a data network is required. In one embodiment, the initial user set up and registration is carried out through a HTTP connection through the mobile data network of the mobile device. In another embodiment, the initial user set up and registration is carried out using a Web browser on a personal computer separate from the mobile device. User set up and registration involve assigning a user ID to the user and establishing billing information. The user may also store a list of authorized caller IDs for the user's account. In the present description, a “caller ID” refers to the caller identification or source telephone number of the caller. That is, the caller ID is the telephone number, whether a mobile device or a landline telephone, from which the caller is placing the call. The call mapping and routing system 10 of the present invention allows the user to list all of the caller IDs associated with the user or all the caller IDs that are authorized to access the user's account, including mobile telephone numbers and landline telephone numbers.

Once the initial user set up and registration is completed, a mobile device can utilize system 10 of the present invention with or without a mobile data network. When a mobile data network is available, a mobile device user can place an international call by directly dialing the international telephone number. When no mobile data network is available, the mobile device user can make an international call by dialing a pre-assigned local DID number, as will be described in more detail below. A landline telephone can also utilize system 10 after user registration through the use of the pre-assigned local DID number, as will be described in more detail below. In the present embodiment, FIG. 1 illustrates the operation of call mapping and routing system 10 when a mobile data network 14 is available. Mobile data network 14 can include wireless data networks such as Wi-Fi, 3 G, EDGE, GPRS, and others. In other embodiments, mobile data network 14 is optional and is not required to access the functions and features of the call mapping and routing system of the present invention, as will be described in more detail below.

In one embodiment, when caller 12 is using a mobile device to access system 10, a software application is installed on the mobile device to facilitate the call mapping and routing method of the present invention. One example of the software application is an applet for an iPhone. In one embodiment, caller 12, wishing to place an international call, dials an intentional telephone number from the mobile device. Caller 12 of the mobile device may place the call by entering the destination telephone number or by selecting a destination telephone number from a list of contacts stored on the mobile device's contact directory.

When the international number is dialed, the software application installed on the mobile device, which is assumed to be a smartphone with mobile data network communication capability, sends HTTP requests through mobile data network 14 to an Application Server 16. The mobile device is also capable of receiving HTTP responses from Application Server 16. In another embodiment, the software application communicates with Applicant Server 16 through a SMS (short message service) connection. Application Server 16 implements user authentication and also performs local DID assignment. In the present embodiment, Application Server 16 includes an interface module 17 for interfacing with mobile data network 14 and a temporal DID assignment module 18 for assigning a local DID number to caller 12.

In operation, Application Server 16 accesses a database 20 having stored thereon a block of local DID numbers which are shared among all of the users of the call mapping and routing system 10. Database 20 also stores user account information and a mapping table of local DIDs to destination numbers mapping for each user of system 10. Mobile device 12 sends

The software application on the mobile device 12 sends the user ID, the caller ID and the dialed International number to Application Server 16 through a HTTP request. When Application Server 16 receives the HTTP request, the Application Server accesses database 20 to authenticate the caller's user ID and caller ID. That is, Application Server 16 determines whether the user ID is valid and whether the caller ID is an authorized caller ID for that user. Once authenticated, Application Server 16 assigns a local DID number to the destination number (i.e. the International number) dialed by the caller. The assignment of the local DID number is associated with the user ID of the user and is therefore unique to each user, as will be described in more detail below. The mapping of each local DID to the destination numbers for each user is stored in a mapping table on database 20.

In one embodiment, when assigning local DID numbers, Application Server 16 selects a local DID number based on the current caller ID of the call. That is, the Application Server 16 selects a local DID number having the same area code as the caller ID of the caller. If no local DID number is available from the same area code, then a local DID number from the neighboring area code is assigned.

When Application Server 16 determines the local DID number to be assigned to caller 12, Application Server 16 returns the assigned local DID number to the mobile device of caller 12 through HTTP responses. The software application on the mobile device of caller 12 then places the call by dialing the assigned local DID number through the mobile carrier's PSTN network 22. In an alternate embodiment, the Applicant Server 16 returns the assigned local DID number using text messaging, such as short message service (SMS), to the mobile device of caller 12.

In one embodiment, the local DID assignment is only temporary. The local DID assignment is only valid for the call duration and the assignment is released once the call is terminated. In another embodiment, the caller has the option of storing the assigned local DID number permanently, such as by storing the assigned local DID number to the contact directory in the mobile device. When the caller selects the option to store the assigned local DID number, Application Server 16 permanently assigns the mapped local DID number to the specific international number dialed by the caller. The permanently assigned local DID number is associated with the user ID of the caller. The mapping of the assigned local DID number to the specific destination international number for that user ID is stored in the mapping table in database 20. Accordingly, subsequent dialing of that international number is carried out simply by dialing the stored local DID number associated with that destination number. For example, a mobile device user can call the same international number by directly dialing the local DID number or by selecting a contact in the contact directory. When the caller uses a pre-assigned local DID number to make a call, no further mapping is required and thus communication with the Application Server 16 is not needed, eliminating the need for a Wi-Fi or mobile data network.

Returning to FIG. 1, the call placed using the assigned local DID number reaches an origination gateway 24, also referred to as an inbound gateway, for PSTN-to-IP conversion. The origination gateway 24 converts the received PSTN call to a Voice over IP (VoIP) session and initiates a VoIP call session to Control Signaling Servers 26. Control Signaling Servers 26 perform basic call functions such as call session initiation and control. Control Signaling Servers 26 provides the necessary control signals to establish a voice-based connection between the caller and the caller. Control Signaling Servers 26 can utilize various Internet telephony protocol to accomplish the call control signaling operations. In one embodiment, Control Signaling Servers 26 perform various call functions, including but are not limited to, user authentication, destination number reverse lookup, call signaling and routing, and billing. In the present embodiment, Control Signaling Servers 26 includes an interface module 28 for interfacing with the origination gateway 24 and a reverse lookup module 30 operating to retrieve the destination phone number based on the dialed local DID number and the caller ID. The Control Signaling Servers 26 also includes a call signaling and billing module 31 for handling call signaling and routing to a termination gateway 32 and handling billing of the telephone call.

In some embodiments of the present invention, Control Signaling Servers 26 are implemented using an Internet Telephony protocol selected from the several well-known Internet Telephony protocols, including SIP, H.323, MGCP, IMS and others. In other embodiments of the present invention, Control Signaling Servers 26 are implemented as a softswitch. A softswitch is a software-enabled method of connecting one or more communication endpoints (such as phone lines) with each other. The use of softswitch in telecommunication networks is well known. Softswitch supports multiple protocols including SIP, H.323, and others, and is capable of supporting protocol conversion, such as from SIP to H.323 or from H.323 to SIP. In one embodiment, Control Signaling Servers 26 are implemented as Session Initiation Protocol (SIP) Servers. In the present description, SIP Servers refer to the group of SIP components required to provide Internet Telephony services based on the SIP Internet telephony protocol. The group of SIP components can include a SIP proxy, a SIP client, a B2 B proxy, a registrar, and others. SIP Servers and softswitch both perform the same basic function of call session initiation and control for establishing a voice-based connection between the caller and the caller. SIP servers use SIP protocol to implement these call functions while a softswitch uses various protocols including SIP to implement the same call functions.

At Control Signaling Servers 26, reverse look-up of the local DID number is performed to determine the intended destination number for the call. More specifically, based on the dialed local DID number and the caller ID of the caller, Control Signaling Servers 26 perform user authentication and retrieve the destination number from the mapping table stored in database 20. Control Signaling Servers 26 search in the database for the caller ID to determine if it is an authorized caller ID for a given user. Once the caller ID is authenticated, Control Signaling Servers 26 perform reverse lookup to retrieve the destination phone number mapped to the dialed local DID number. Once the intended destination number is retrieved, the call is passed to termination gateway 32 to route the call to the intended destination number. The call can be routed through a PSTN 34 to a callee 36 using a mobile device or a landline telephone. The call can also be routed through the Internet as a VoIP call to a VoIP communication terminal.

In some embodiments of the present invention, the call mapping and routing system and method of the present invention allows multiple telecommunication devices, such as landline telephones or other mobile devices, to use a single user account and to access the same contact phone list with pre-assigned local DID numbers. In this manner, multiple telecommunication devices can share the same local DID number to reach the same destination number. For instance, a user accesses the call mapping and routing system and method of the present invention through a webpage and set up a list of contacts with pre-assigned local DID numbers mapped to destination telephone numbers. The user also identifies the authorized caller IDs that can access the account. The authorized caller IDs can be the user's mobile phone number, home phone number, work phone number or other wireless or landline telephone numbers from which the user may place calls. A caller may then place a call using a device having one of the authorized caller IDs to destination phone numbers by dialing the pre-assigned local DID numbers. The call mapping and routing system authenticate the user by verifying the caller ID of the caller matches one of the authorized caller IDs stored for the user.

In this manner, the call mapping and routing system and method of the present invention support telephone calls from landline telephones as well as mobile telephones. When a call from a landline telephone is received by the call mapping and routing system of the present invention, the Control Signaling Servers authenticate the landline caller ID and dials the destination phone number associated with the dialed local DID number.

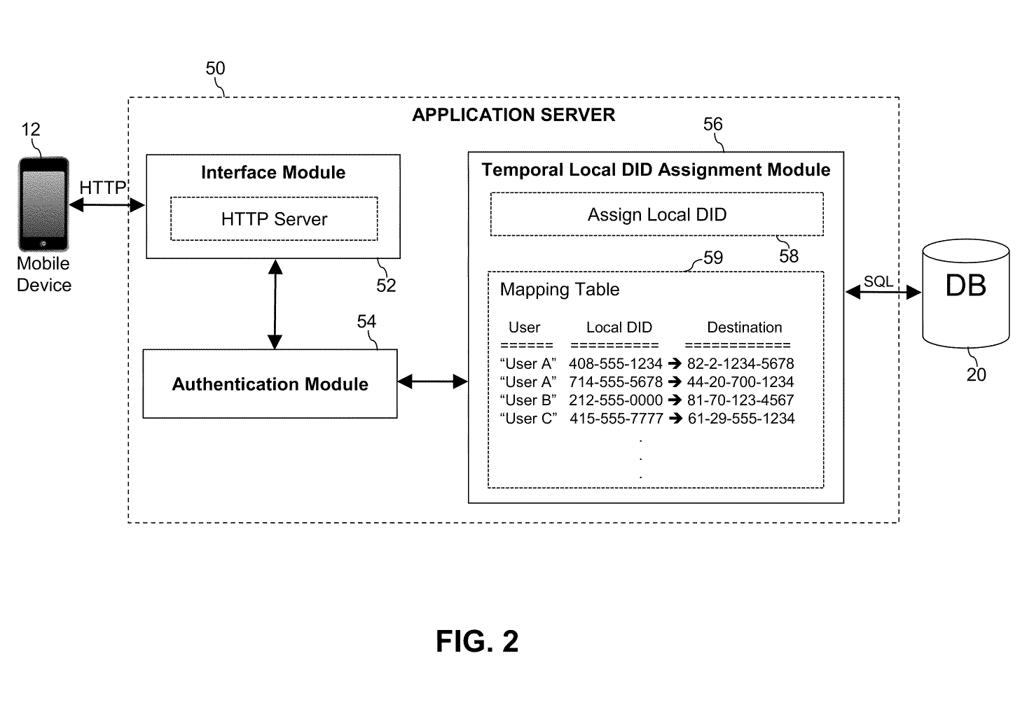

FIG. 2 is a block diagram of the Application Server in the call mapping and routing system of FIG. 1 according to one embodiment of the present invention. Referring to FIG. 2, Application Server 50 in the call mapping and routing system of the present invention communicates with a mobile device 12 through HTTP protocols. In the present embodiment, Application Server 50 includes an interface module 52, an authentication module 54 and a temporal local DID assignment module 56. Interface module 52 supports the HTTP communication. When a call is to be placed from mobile device 12, the software application on mobile device 12 transmits a HTTP requests including the user ID, the caller ID and the destination number dialed by the user of mobile device 12. Authentication module 54 performs user authentication using the user ID and the caller ID. When the user is authenticated, the temporal local DID assignment module assigns a local DID number mapped to the destination for the user.

FIG. 2 illustrates an exemplary mapping table stored on database 20 for storing the local DID number and destination number mapping for each user. In the present embodiment, Application Server 50 retrieves information from database 20 using SQL commands. It is instructive to note that the mapping table is actually stored on database 20 but is shown as being part of the temporal local DID assignment module 56 only for the purpose of illustrating the format of the mapping table. In the mapping table shown, temporal local DID assignment module 56 assigns a local DID to the user based on the caller ID of the user. In the present illustration, a “user A” have been assigned two local DID numbers, each for a different destination phone number. Users “B” and “C” are each assigned different local DID numbers for their respective destination numbers. A user (such as user A) may have multiple assigned local DID numbers for each of the different destination phone numbers the user wishes to dial.

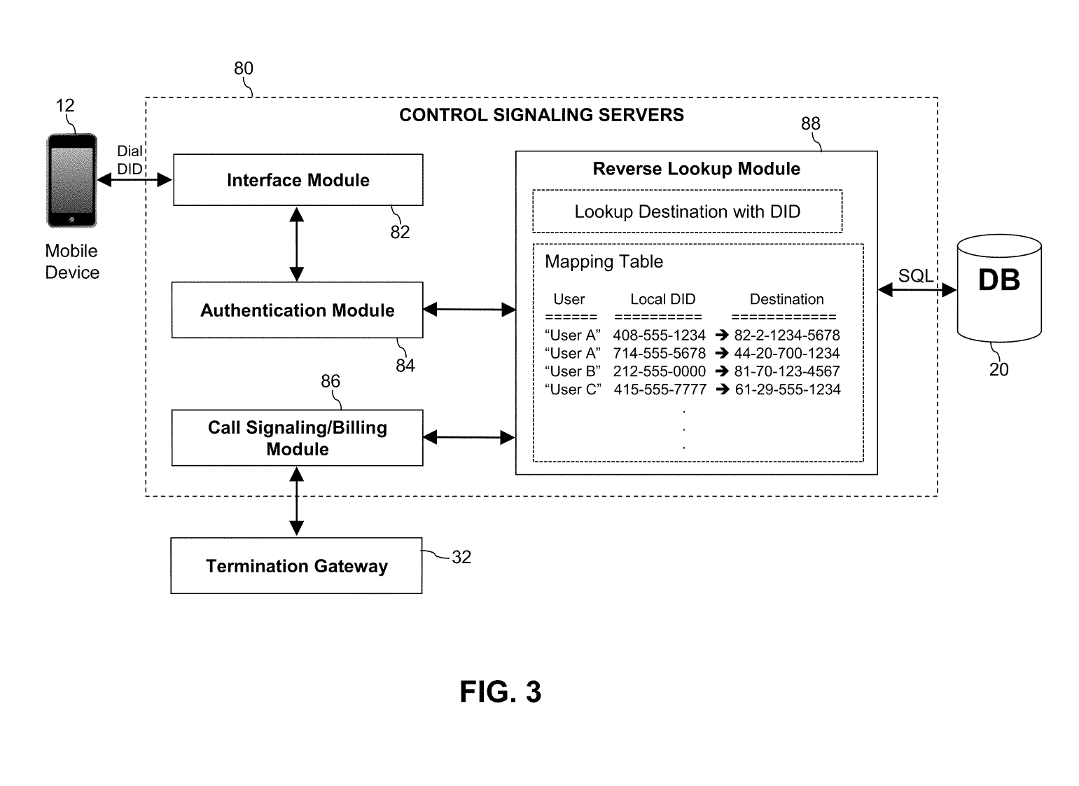

FIG. 3 is a block diagram of the Control Signaling Servers in the call mapping and routing system of FIG. 1 according to one embodiment of the present invention. Referring to FIG. 3, Control Signaling Servers 80 receive the dialed local DID number from the mobile device 12 through a gateway (such as origination gateway 24 in FIG. 1). Control Signaling Servers 80 include an interface module 82 for interface with the origination gateway, an authentication module 84 for authenticating the caller, and a call signaling and billing module 86 for handling call signaling and billing. Control Signaling Servers 80 also include a reverse lookup module 88 for retrieving from database 20 the intended destination number mapped to the local DID number based on the caller ID of the call placed.

More specifically, when the dialed local DID number is received by the interface module 82, Control Signaling Servers 80 perform user authentication using the caller ID. Authentication module 84 looks up the caller ID to determine if it is an authorized caller ID from a user. Then, reverse lookup module 88 retrieves the local DID number to destination number mapping for that user to look up the dialed local DID number. The intended destination number is then obtained. The intended destination number is passed to call signaling and billing module 86 to be passed onto termination gateway 32 to route the call to the intended destination. Control Signaling Servers 80 can be implemented using one of the several Internet Telephony protocols, such as SIP or H.323, MGCP, and IMS or others. Control Signal Servers 80 can also be implemented as a softswitch.

The call mapping and routing system of the present invention provides many flexibility in local DID assignment and the same set of local DID numbers can be intelligently applied to a large number of users. As described above, each local DID to destination number mapping is associated with each user and associated caller ID. Therefore, a user may have multiple pre-assigned local DID numbers for multiple destination addresses. Furthermore, the same local DID number can be assigned to multiple users as long as each user has their own unique caller ID which is typically the case. In the case when two users having different caller IDs are pre-assigned to the same local DID number, the local DID number can be mapped to different destination numbers or even to the same destination numbers.

Table 1 below is an exemplary mapping table for the call mapping and routing system according to one embodiment of the present invention.

| | Caller ID | Local DID | Destination |
|---|---|---|---|
| User A: | 408-555-1000 | 408-555-9999 | +44-20-712-0987 |
| User B: | 408-555-2000 | 408-555-9999 | +44-20-712-0987 |
| User C: | 302-444-3200 | 302-555-1234 | +82-2-1234-5678 |
| User C: | 302-444-3200 | 714-555-5678 | +44-20-700-1234 |
| User C: | 212-888-8898 | 212-555-0000 | +81-70-123-4567 |
| User C: | 212-888-7787 | 212-555-0000 | +81-70-123-4567 |

In Table 1, user A and user B are assigned the same local DID number mapped to the same destination number. The two users are identified by their unique caller ID. For example, user A and user B may be family members who both wish to call the same person in UK (country code 44). The call mapping and routing system of the present invention can assign the same local DID number to user A and user B but each user will be authenticated by their own unique caller ID.

In Table 1, user C is assigned three different local DID numbers. First, two different local DID numbers are assigned to two different destinations but associated with the same caller ID. Thus, user C, calling from a phone with the caller ID 302-444-3200 may dial the local DID numbers to reach one or the other destinations. Second, user C has specified three different caller ID numbers. User C may have two different caller IDs (area code 212) both assigned to the same local DID number to call the same destination number.

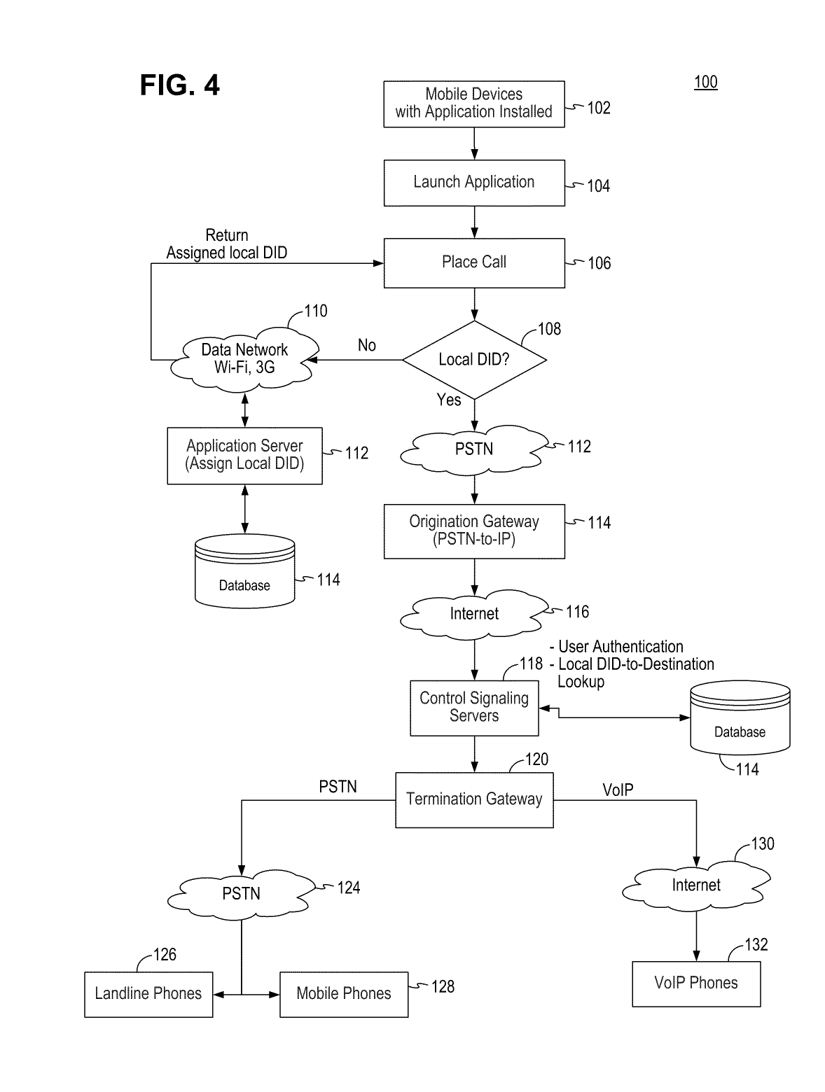

FIG. 4 is a flowchart illustrating the call mapping and routing method using an installed software application on the mobile device according to one embodiment of the present invention. Call mapping and routing method 100 of FIG. 4 will be describes with reference to system 10 of FIG. 1. Referring to FIG. 4, in the present embodiment, a software application is installed on the mobile device to facilitate the call mapping and routing method of the present invention (step 102). To initiate a call, the caller 12 launches the software application (step 104). The user of the mobile device (the “caller”) places a call by dialing a phone number directly or by selecting a phone number from a list of contacts (step 106). The dialed number can be a destination telephone number, such as an international telephone number, or a local DID number. Method 100 determines whether the dialed number is a local DID number (step 108).

When the dialed number is a destination phone number and not a local DID number, the software application on the mobile device sends the dialed international number to the Application Server 16 through a mobile data network 110, such as a Wi-Fi network or other mobile data networks, such as 3 G, Edge, or other types of networks. In one embodiment, the software application sends a HTTPS POST request through the mobile data network 110 to the Application Server. The software application pass along the user ID and the caller ID of the caller and the dialed destination number to Application Server 16. The user ID refers to a system-wide unique numeric ID assigned to the user (e.g. 10309252). The caller ID refers to the phone number of the mobile device (e.g. 408-555-1234). Finally, when the dialed destination number is an international phone number, the dialed destination number includes the country code and the local area code and phone number (e.g. 82-2-2164-9000).

At step 112, the Application Server 16 authenticates the caller 12 using the user ID and the caller ID. In one embodiment, the authentication process includes checking if the user ID exists in system database 114 as well as checking if the caller ID exists in the caller ID list of the user. The user can associate multiple caller IDs such as home phone number, office phone number, and mobile phone number to the user ID of the user. Therefore, each user ID may have multiple caller ID associated therewith. Once authenticated, the Application Server 16 assigns a temporary local DID number to the dialed international number (step 112).

In one embodiment, the Application Server selects a local DID number by parsing the caller ID of the caller (“408-555-1234”) and extracting the area code of the caller ID. For example, from “408-555-1234”, the area code “408” is extracted. The Applicant Server then retrieves a local DID number with the same area code (e.g. 408-200-8000). If no local DID number is available with the same area code, a local DID number with a neighboring area code is used (e.g. 510-123-7777).

The Application Server stores the selected local DID number and the mapped destination number associated with the caller ID of the user into the mapping table on database 114. Accordingly, in one embodiment, an entry of the following mapping is stored in the mapping table in database 114:

| | Caller ID | Local DID | Destination |
|---|---|---|---|
| User A: | 408-555-1234 | 408-200-8000 | 82-2-2164-9000 |

The Application Server 16 sends the assigned local DID number back to the software application of the mobile device through the mobile data network. In embodiment, the assigned local DID number is sent to the software application in the form of an XML document: “XML: 408-200-8000”. The software application parses the XML document and extract the assigned local DID number. In another embodiment, the assigned local DID number is sent to the software application using on text messaging, such as short message service (SMS).

Once the assigned local DID number is returned to the software application through XML or other Web service methods, the software application dials out the assigned local DID number (step 106) through the mobile carrier network (PSTN) 112, such as AT&T, Verizon, Sprint, T-Mobile, or other networks.

The call placed with the assigned local DID number reaches an origination gateway 24 for PSTN-to-IP conversion (step 114). The origination gateway receives the call from PSTN with the following information: caller ID=408-555-1234 and dialed number=408-200-8000. The origination gateway converts the received PSTN call to a Voice over IP (VoIP) session, such as SIP, H.323, MGCP, IMS and others. The origination gateway initiates a VoIP call session through the Internet 116 to the Control Signaling Servers 26 (step 118). More specifically, the origination gateway sends a VoIP call setup signal to the Control Signaling Servers with the following information: caller ID=408-555-1234 and dialed number=408-200-8000.

Upon sending VoIP call setup to the Softswitch, the Control Signaling Servers perform user authentication using the caller ID and perform reverse lookup to retrieve the mapped destination number in the mapping table stored in database 114 based on the caller ID. More specifically, the Control Signaling Servers first determine if the caller ID 408-555-1234 belongs to a valid user of the system. Once the caller ID is authenticated, the Control Signaling Servers perform reverse lookup from the mapping table in database 114 to find the intended destination number associated with the dialed local DID number 408-200-8000. From the mapping table (such as the table entry shown above), the intended destination phone number 82-2-2164-9000 is retrieved. The Control Signaling Servers replace the dialed number (408-200-8000) of the VoIP call setup packet with the retrieved destination number. The Control Signaling Servers then send out the modified Voice over IP call packet to a termination gateway (step 120). The termination gateway routes the call through a PSTN 124 (after IP-to-PSTN conversion) to reach mobile phones 128 or landline phones 126 connected to the PSTN network. The termination gateway can also route the call through the Internet 130 to reach VoIP phones or VoIP terminals 132.

In one embodiment, the Control Signaling Servers are implemented as SIP Servers. The origination gateway converts a PSTN call to a Session Initiation Protocol (SIP) call setup message (INVITE) and initiates SIP call session to the SIP Servers with the following information: (a) the caller ID: “FROM” tag value with caller's telephone number and (b) the destination number: “TO” tag value with the assigned local DID number. The SIP Servers authenticate the caller with the caller ID in the FROM tag and perform a reverse lookup to retrieve the actual destination number dialed by the caller based on the assigned local DID number. The retrieved international phone number is put into the “TO” tag to replace the dialed local DID number. The SIP Servers finally obtain the original international number to be dialed and send out INVITE with a “TO” tag value of the international telephone number. The SIP Servers look up routing information and determine whether the call is ON-NET or OFF-NET call. ON-NET call is a call within the service subscribers and OFF-NET call is a call to regular landline or mobile phones.

If the call is an ON-NET call, the SIP Servers directly send INVITE to the subscriber's SIP device through the Internet. If the call is an OFF-NET call, the SIP Servers send INVITE to Internet Telephony Service Provider (ITSP) partners to terminate the PSTN destination. The ITSP converts the SIP call request to a PSTN call setup and finally connects the call to the international party.

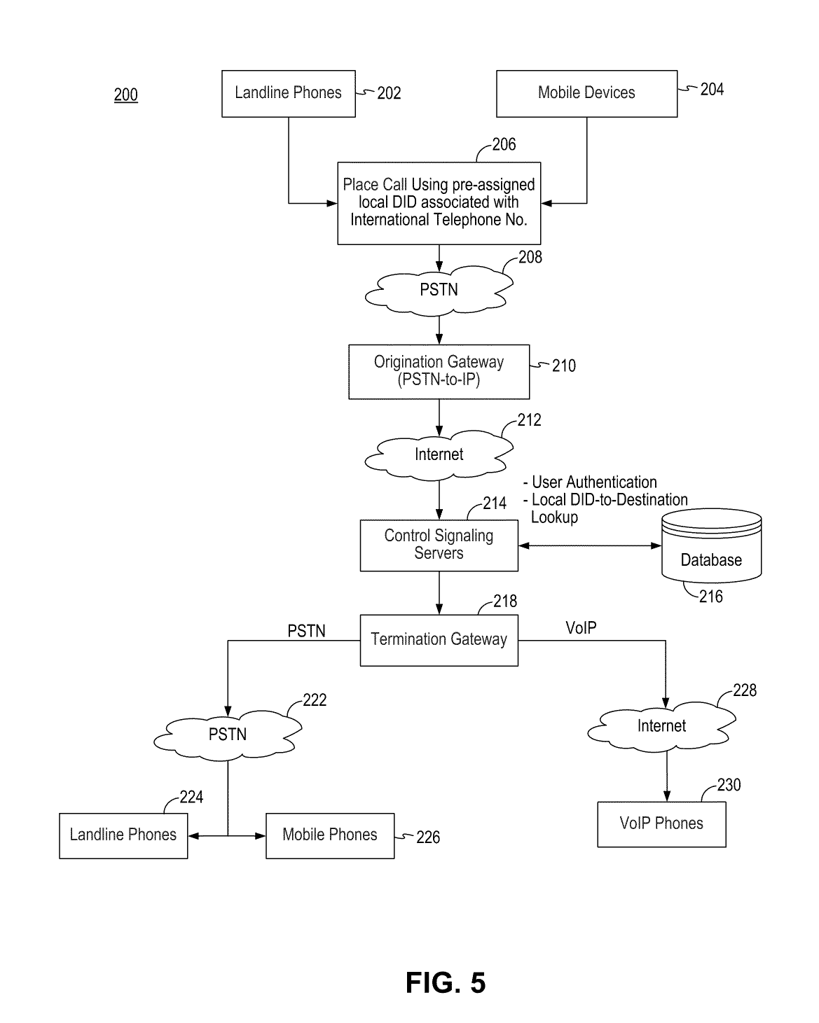

FIG. 5 is a flowchart illustrating the call mapping and routing method without using a mobile data network according to one embodiment of the present invention. In the embodiment shown in FIG. 5, the caller makes a call using a pre-assigned local DID number and no Wi-Fi or mobile data network is required to utilize the call mapping and routing method of the present invention. In this case, a caller has previously dialed a destination number and received an assigned local DID number. The caller elects to store the assigned local DID number permanently as being associated with the destination number for future use. Alternately, the caller can access the Application Server of the call mapping and routing system through a webpage where the caller enters one or more destination phone numbers and has those destination phone numbers assigned to different local DID numbers. When the caller launches the software application on the mobile device, the stored phone numbers and assigned local DID numbers are downloaded and stored on the mobile device. Once the assigned local DID numbers are downloaded, the caller can make calls using the contact list without requiring a Wi-Fi or a mobile data network.

Furthermore, in the present embodiment, a mobile device may use the call mapping and routing method without the software application installed as long as the user have obtained the pre-assigned local DID numbers, such as through user set up on a webpage. A user may also use a landline telephone to access the call mapping and routing method of the present invention by using the pre-assigned local DID numbers.

Referring to method 200, a call can be placed from a landline telephone 202 by dialing a pre-assigned local DID number (step 206). A call can also be placed from a mobile phone 204 with or without the software application installed by dialing the pre-assigned local DID number (step 206). The local DID number is dialed out through the PSTN 208 to an inbound or origination gateway 210 for PSTN-to-IP conversion. The origination gateway converts the received PSTN call to a Voice over IP (VoIP) session, such as SIP, H.323, MGCP, IMS and others. The origination gateway initiates a VoIP call session through the Internet 212 to the Control Signaling Servers (step 214). More specifically, the origination gateway sends a VoIP call setup signal to the Control Signaling Servers with the caller ID and the dialed local DID number.

Upon sending VoIP call setup to the Control Signaling Servers, the Control Signaling Servers perform user authentication using the caller ID and perform reverse lookup to retrieve the mapped destination number in the mapping table stored in database 216 based on the caller ID. More specifically, the Control Signaling Servers first determine if the caller ID belongs to a valid user of the system. Once the caller ID is authenticated, the Control Signaling Servers perform reverse lookup from the mapping table in database 216 to find the intended destination number associated with the dialed local DID number. From the mapping table, the intended destination phone number is retrieved. The Control Signaling Servers replace the dialed number of the VoIP call setup packet with the retrieved destination number. The Control Signaling Servers then send out the modified Voice over IP call packet to the termination gateway (step 218). The termination gateway routes the call through a PSTN 222 (after IP-to-PSTN conversion) to reach mobile phones 226 or landline phones 224 connected to the PSTN network. The termination gateway can also route the call through the Internet 228 to reach VoIP phones or VoIP terminals 230.

The above detailed descriptions are provided to illustrate specific embodiments of the present invention and are not intended to be limiting. Numerous modifications and variations within the scope of the present invention are possible. The present invention is defined by the appended claims.

We claim:

1. A method for providing international telephone call service to a calling party using a public switched telephone network (PSTN) enabled communication device, the method comprising:
launching a software application installed on the communication device of the calling party;
dialing a destination telephone number;
establishing a connection over a mobile data network between the software application and an application server;
providing an user identification (user ID) and a caller identification (caller ID) of the calling party and the destination telephone number to the application server;
authenticating the calling party using the user ID and the caller ID;
when the calling party is authenticated, assigning a local direct inward dial (DID) number having the same area code as the caller ID or having a neighboring area code as the caller ID;
notifying the communication device of the calling party of the assigned local DID number through the mobile data network;
storing the mapping of the assigned local DID number to the destination telephone number associated with the calling party in a database;
initiating a telephone connection over the PSTN to the destination telephone number by dialing the assigned local DID number from the PSTN enabled communication device;
authenticating the calling party using the caller ID of the calling party;
when the calling party is authenticated, retrieving the destination telephone number associated with the assigned local DID number from the database; and
establishing a voice-based connection between the communication device of the calling party and a communication device of a receiving party associated with the destination telephone number.

2. The method of claim 1, wherein the PSTN enabled communication device comprises a mobile device or a landline telephone.

3. The method of claim 1, wherein establishing a connection over a mobile data network between the software application and an application server comprises:
establishing a HTTP connection over the mobile data network between the software application and the application server.

4. The method of claim 1, wherein establishing a connection over a mobile data network between the software application and an application server comprises:
establishing a SMS connection over the mobile data network between the software application and the application server.

5. The method of claim 1, wherein storing the mapping of the assigned local DID number to the destination telephone number associated with the calling party in a database comprises:
storing the mapping of the assigned local DID number to the destination telephone number associated with the user ID and the caller ID of the calling party in the database.

6. The method of claim 1, wherein after initiating a telephone connection over the PSTN to the destination telephone number, the method further comprises:
converting the PSTN telephone connection to a Voice over IP (VoIP) call session.

7. The method of claim 7, wherein converting the PSTN telephone connection to a Voice over IP (VoIP) call session comprises converting the PSTN telephone connection to a Voice over IP (VoIP) call session using an Internet Telephony Protocol selected from SIP, H.323, IMS and MGCP.

8. The method of claim 1, wherein retrieving the destination telephone number comprises:
querying the database to search for the local DID number dialed by the calling party to obtain the destination telephone number mapped to the dialed local DID number and associated with the caller ID of the calling party.

9. The method of claim 1, wherein establishing a voice-based connection between the communication device of the calling party and a communication device of a receiving party associated with the destination telephone number comprises:
converting the VoIP call session to a PSTN call session; and
routing the PSTN call session to the destination telephone number through a PSTN.

10. The method of claim 1, wherein establishing a voice-based connection between the communication device of the calling party and a communication device of a receiving party associated with the destination telephone number comprises:
routing the VoIP call session over a data network to a VoIP terminal associated with the destination telephone number.

11. The method of claim 1, wherein the assigned local DID number is provided and stored only for the duration of the telephone connection.

12. The method of claim 1, wherein the assigned local DID number is stored in the communication device and in the database for a subsequent telephone connection to the same destination telephone number.

13. The method of claim 1, wherein notifying the communication device of the calling party of the assigned local DID number through the mobile data network comprises:
notifying the communication device of the calling party of the assigned local DID number through a short message service (SMS) connection over the mobile data network.

14. A system for providing international telephone call service to a calling party using a public switched telephone network (PSTN) enabled communication device, comprising:
a software application installed on the communication device of the calling party;
an application server in communication with the software application through a mobile data network, the application server configured to authenticate the calling party's identity and to assign a local direct inward dial (DID) number mapped to a destination telephone number associated with the calling party;
a database in communication with the application server configured to store a mapping table of local DID numbers to destination telephone numbers for one or more calling parties;
control signaling servers in communication with the PSTN and the database to establish an Internet telephony call session, to authenticate the calling party's identity, to retrieve the destination telephone number mapped to a local DID number associated with the calling party, and to route the call session to an intended destination telephone number,
wherein the calling party launches the software application and dials the destination telephone number, the application server assigns a local DID number mapped to the destination telephone number to the calling party; the software application, upon receiving the assigned local DID number, initiates a telephone connection over the PSTN; the control signaling servers, after performing authentication of the calling party and retrieving the destination telephone number mapped to the assigned local DID number, establishes a voice-based connection between the communication device of the calling party and a communication device of a receiving party associated with the destination telephone number.

15. The system of claim 14, wherein the application server assigns a local DID number to a calling party using a caller identification (caller ID) of the calling party, the local DID number having the same area code or having a neighboring area code as the area code of the caller ID.

16. The system of claim 14, wherein the telephone connection over the PSTN is converted to a Voice over IP (VoIP) call session at an origination gateway.

17. The system of claim 16, wherein the control signaling servers receive the VoIP call session from the origination gateway and establish the voice-based connection with the communication device of the destination telephone number through a termination gateway to a PSTN or to a data network.

18. The system of claim 14, wherein the control signaling servers comprise Session Initiation Protocol (SIP) servers.

19. The system of claim 14, wherein the control signaling servers comprise a softswitch.

20. A method for providing international telephone call service to a calling party using a public switched telephone network (PSTN) enabled communication device, the method comprising:
initiating a telephone connection over the PSTN to the destination telephone number by dialing the destination telephone number;
establishing a connection over a mobile data network between a software application installed on the communication device of the calling party and an application server;
providing an user identification (user ID), a caller identification (caller ID) and the destination telephone number to the application server;
authenticating the calling party using the user ID and the caller ID of the calling party;
when the calling party is authenticated, assigning a local direct inward dial (DID) number having the same area code as the caller ID or having a neighboring area code as the caller ID;
notifying the communication device of the calling party of the assigned local DID number through the mobile data network;
storing the destination telephone number received from the communication device of the calling party and the assigned local DID number in a database;
initiating a telephone connection over the PSTN to SIP servers or softswitch by dialing the assigned local DID number;
authenticating the calling party using the caller ID of the calling party;
when the calling party is authenticated, retrieving the destination telephone number associated with the local DID number and the caller ID of the calling party from the database; and
establishing a voice-based connection between the communication device of the calling party and a communication device of a receiving party associated with the destination telephone number.

21. The method of claim 20, wherein the PSTN enabled communication device comprises a mobile device or a landline telephone.

22. The method of claim 20, wherein establishing a connection over a mobile data network between a software application installed on the communication device of the calling party and an application server comprises:
establishing a HTTP connection over the mobile data network between the software application and the application server.

23. The method of claim 21, wherein establishing a connection over a mobile data network between a software application installed on the communication device of the calling party and an application server comprises:
establishing a SMS connection between the software application and the application server.
